(19) United States
(12) Patent Application Publication
(10) Pub. No.: US 2014/0013451 A1
(43) Pub. Date: Jan. 9, 2014

(54) DATA OBFUSCATION FOR OPEN DATA (ODATA) COMMUNICATIONS

(71) Applicants: Peter Kulka, Heidelberg (DE); Frank Albrecht, Walldorf (DE)

(72) Inventors: Peter Kulka, Heidelberg (DE); Frank Albrecht, Walldorf (DE)

(73) Assignee: SAP AG, Walldorf (DE)

(21) Appl. No.: 13/543,046

(22) Filed: Jul. 6, 2012

(51) Int. Cl. G06F 21/24

(52) U.S. Cl. 726/29

(57) ABSTRACT

Techniques and configurations for implementing data obfuscation for Representational State Transfer (RESTful) web service communications such as those communicated using an Open Data (OData) protocol are described. In one example embodiment, an obfuscation service includes an OData client, an OData server, and an OData obfuscation data server, the obfuscation service operating to intercept and process OData web service requests being transmitted from requesting clients to backend enterprise data services. The obfuscation service may include or integrate with an obfuscation engine, including a context engine, a rules engine, and a hierarchical mapping engine to determine rules for data obfuscation based on determined context and hierarchical mappings. The obfuscation service may apply the determined rules to provide specific access control and data obfuscation results of data retrieved from the backend enterprise services.

### FIELD

The present disclosure relates generally to data operations and controls. In an example embodiment, the disclosure relates to the management of access controls for certain data and the obfuscation of such data in web services, such as web services communicating using an Open Data (OData) channel.

### BACKGROUND

Data obfuscation can be used to modify, manipulate, or change sensitive data originating from one or more backend systems before presentation to an end user, while keeping the original data in the backend systems unchanged. In many scenarios, access to sensitive data is controlled via user roles that allow or deny access to entire business objects or documents. The desired state of obfuscation, however, may be to implement detailed access control so that only certain portions of the business objects, documents, or other data are obfuscated. Existing approaches fail to provide detailed access control for data obfuscation without significant modifications in backend systems, or complex rule sets that require extensive modifications to customer user interfaces used to access the backend systems.

### BRIEF DESCRIPTION OF DRAWINGS

The present disclosure is illustrated by way of example and not limitation in the figures of the accompanying drawings, in which like references indicate similar elements and in which:

FIG. 1A is a block diagram depicting an architectural overview of a system facilitating RESTful web service communications using an open data (OData) protocol, used in accordance with an example embodiment;

FIG. 1B is a block diagram depicting an architectural overview of a system providing data obfuscation and facilitating RESTful web service communications using an open data (OData) protocol, used in accordance with an example embodiment;

FIG. 2 is a block diagram depicting an overview of an obfuscation service used in accordance with an example embodiment;

FIG. 3A is an illustrated example of data views implementing levels of data obfuscation for different end users based on access level provided in accordance with an example embodiment;

FIG. 3B is an illustrated example of a table showing mappings of data outputs based on a security level being provided from an obfuscation service, in accordance with an example embodiment;

FIG. 3C is an illustrated example of a table showing output of a data view provided based on a security level being from an obfuscation service, in accordance with an example embodiment;

FIG. 4A is a diagram illustrating a view of a hierarchical relationship of users, in accordance with an example embodiment;

FIG. 4B is a diagram illustrating a view of a hierarchical relationship of security levels, in accordance with an example embodiment;

FIG. 4C is a diagram illustrating mappings of a hierarchical relationship between users and security levels, in accordance with an example embodiment;

FIG. 4D is a diagram illustrating mappings of a hierarchical relationship between users and user categorizations, in accordance with an example embodiment;

FIG. 5 depicts a flow diagram of a general overview of a method for performing data obfuscation of a web service request with an obfuscation service, in accordance with an example embodiment;

FIG. 6 depicts a Cow diagram of a general overview of a method for applying data obfuscation techniques to data of a web service request, in accordance with an example embodiment; and

FIG. 7 is a block diagram depicting a machine in the example form of a computing device within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Some of the example embodiments described herein provide a method and system for implementing data obfuscation for web service communications, such as standardized web service communications occurring over an Open Data (“OData”) Channel. In one example, a Data Obfuscation Solution is configured to intercept OData requests originating from an OData client system (such as a mobile device, personal computer, or other target system) to a backend system (such as a server, ERP, CRM, or other enterprise data source). Within the Data Obfuscation Solution, a rule engine, such as an Obfuscation Engine, may apply various data obfuscation or manipulation techniques to the data, according to a data obfuscation context, rules, and hierarchical mappings and relationships.

The data obfuscation context (and the ultimate view of obfuscated data) may be influenced by any number of factors or considerations. The contexts may include system contexts that retrieve system-determined information about the user or client (such as user roles, user hierarchies, alert levels, and the like) and determine the amount and type of data obfuscation needed for the user or client. The contexts may also include situational contexts of the user or client that retrieve situational information about the client (such as current user location, device type, business data information, and the like), to determine the amount and type of data obfuscation needed for the current data retrieval. The Data Obfuscation Solution may factor such system or situational contexts in addition to rules when applying obfuscation techniques to data.

Prior to discussing specific example embodiments, further descriptions of some terms are now provided for a better understanding of the descriptions set forth herein.

“Data Obfuscation,” as used herein, may refer to any number of techniques to encode, scramble, mask, disguise, encrypt, substitute, remove, hide, obscure, or otherwise obfuscate the output of sensitive data, whether, in textual, graphical or multimedia format. As one example, data obfuscation may involve the replacement of an original data value such as a number with a range of numbers surrounding the original number. As another example, data obfuscation may entirely remove the original data value, mask the original data value, or not provide any indication that the data value (or even the data field) exists. As another example, data obfuscation may provide misleading data by replacing the original data value with another similar or non-similar data value. The amount, type, and result of data obfuscation may be dependent on any number of variables, and may be correlated to specific user requirements or access control characteristics.

“OData,” as used herein, may refer to the Open Data Protocol, an open web protocol for querying and communicating data using Representational State Transfer (REST) web services. OData enables the creation and use of HyperText Transfer Protocol (HTTP)-based data services, which allow resources identified using Uniform Resource Identifiers (URIs) and defined in an abstract data model, to be published and edited by Web clients using simple HTTP messages. OData typically uses commonly deployed web technologies such as Transmission Control Protocol (TCP), HTTP, Atom Publishing Protocol, XML, and JavaScript Object Notation (JSON) to exchange data between systems. The results of OData queries (payloads) are typically structured in readily parseable formats, such as Atom, JSON, or XML, and may be parsed by any number of client libraries provided by platforms such as .NET, Silverlight, Java, AJAX, PHP, and mobile development platforms. OData, as used herein, may refer to any standardized or non-standardized version of the OData protocol, or like web protocols (e.g., Google Data Protocol (GData)) communicating using REST-based web service communication techniques.

“OData Channel,” as used herein, may refer to a channel of communications using OData, provided to connect with a specific enterprise data service to obtain enterprise data. Examples of an enterprise data service include, for example and not for limitation, Customer Relationship Management (CRM) services, ERP (Enterprise Resource Planning) systems, MIS (Management Information Service) systems, Content Management (CM) services, Human Resource Management (HRM) services, payment services, accounting or invoicing services, business intelligence services, document management services, or other information system services configured to maintain, provide, or facilitate enterprise or business-related data. Such enterprise data services may be operated in an on-demand manner in a Software-as-a-Service (SaaS) or cloud-based environment, or in a standalone-installation accessible by one or more clients. Examples of enterprise data include, for example and not for limitation, business objects, business documents, notes, bookmarks, annotations, terminology, or any other business data or concepts. In some examples, the enterprise data may be extracted or compiled from heterogeneous sources (e.g., an email database server and a purchase order database). Further, the enterprise data may be structured (e.g., type defined via a schema, such extensible markup language (XML)) or unstructured (e.g., document processing software documents) according to open or proprietary standards.

The present disclosure provides various example methods and configurations to deploy data obfuscation to modify, manipulate, change, obscure, or hide data that is accessed from backend systems, such as an enterprise data service. The data obfuscation may be deployed according to contexts and rules that are defined on such contexts before presentation of specific data to the end user. The original data in the backend systems, however, is typically intended to remain unchanged. The intended result of data obfuscation may be detectable or undetectable by the consuming client, depending on the type of obfuscation and the context of the data retrieval.

Typically in existing systems, access to sensitive data is controlled via user roles that allow or deny the access to entire business objects or documents. For example, sensitive data contained in sales orders, material masters, or employee data may be desired to be secured or obfuscated based on an associated access level of the retrieving user or client system. The desired state of data obfuscation is to enable very detailed access control based on the accessing user, the accessing system, the access situation, and any other number of factors. Existing rule-exclusive access control systems therefore require an exceptionally large amount of complexity or reprogramming to address all of the possible combination of factors for the combination of data fields.

For example, one existing approach to implement detailed access control for data obfuscation is to integrate obfuscation functionality deep in the backend systems. This requires significant modifications that need to be performed in each backend system separately. Each process may need to be changed for each obfuscation and access requirement. Further, if new requirements for the access control must be added later, the system must be modified again. As a consequence, later software upgrades of the backend systems are likely to be expensive and complex.

Another existing approach to implement detailed access control for data obfuscation is to provide rules or policy engines to obfuscate data according to certain rules or contexts (such as user roles, alert levels, and the like). Some of these rules engines manage access control from outside of the backend systems, so that no modifications in the backend systems are needed. However, the user interfaces to the backend systems may need to be redeveloped to communicate properly with the rules engine.

Ideally, data obfuscation can be provided on a data field level, based not only on user roles, but also on dynamic aspects, such a user location (e.g., Global Positioning System (GPS) coordinates of a user mobile device), user security level, or user device type. Further, systems such as defense-critical system may even want to show varying levels of “misleading information” or otherwise conceal the use of data obfuscation. This level of detailed access control is particularly complex if not impossible with rule-exclusive approaches.

In an example embodiment, an Open Data Obfuscation Solution (OOS), is configured to intercept, capture, or otherwise receive OData requests originating from an OData client being transmitted to an OData service. The OOS provides OData access for the OData service hosted by one or more backend systems (e.g., the enterprise data services such as an ERP or CRM system) for the consuming frontend systems/applications (e.g. mobile devices, personal computers, and other consuming clients of the enterprise data services). From the perspective of the consuming clients, the data is sent directly to the backend; and the OOS may not be visible as a separate entity.

The OOS serves as a middle trusted party to implement and facilitate an appropriate level and content of data obfuscation. Within the OOS, a rules engine, such as an Obfuscation Engine, can be used for defining and implementing rules that affect the results and the parameters of data obfuscation or manipulation operations. Also within the OOS, functionality may be provided to enable context determination for system and situational contexts that affect the results and the parameters of the data obfuscation or manipulation operations.

Use of the OData protocol with an obfuscation solution allows the REST-based exchange of specific types of data and metadata. The OData protocol provides a consuming client with a data access structure that is easier to consume than structured web services such as SOAP-based web services. Specifically, the OData protocol provides for use of a Metadata Document (and a Service Document) that describes resources, identified by Uniform Resource Identifiers (URIs) and defined in a data model, to be accessed with Create, Retrieve, Update, and Delete operations using simple HTTP messages.

The OData protocol also allows a consuming client to obtain other service URIs, and obtain full XML-based information of the available service model, by access to a single URI of the Service Document. Further, the OData protocol allows a data model to be easily exposed through use of a Metadata Document that describes the structure and organization of resources exposed as HTTP endpoints. A wide variety of client applications, whether complex or simple, may parse the Service Document and the Metadata Document to obtain parameters of the data service, and perform simple HTTP web service communications to communicate with such data service.

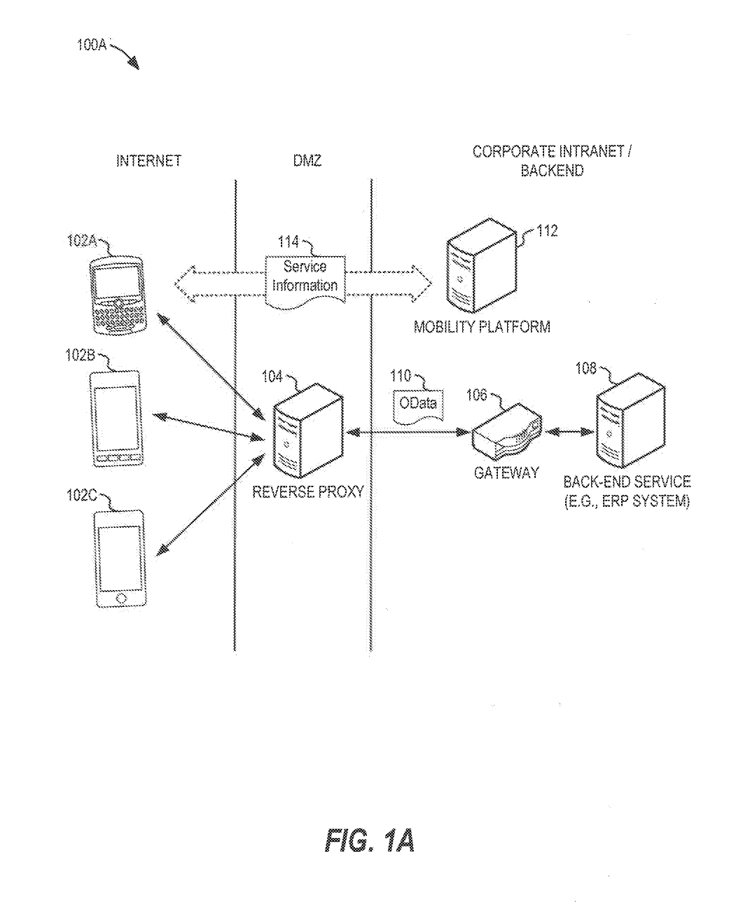

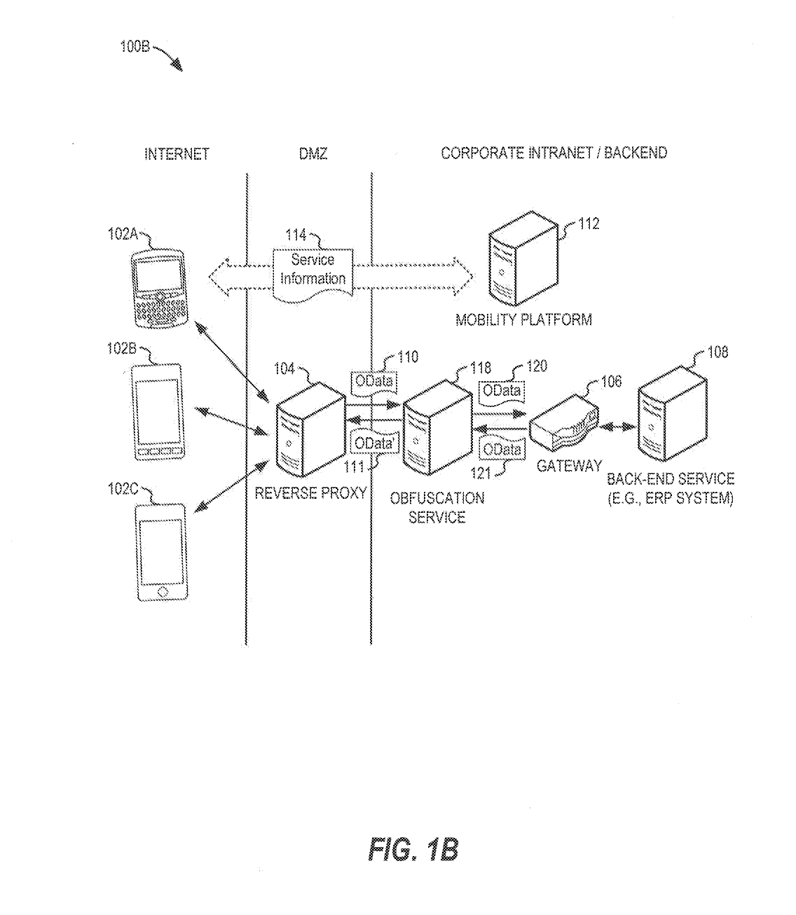

FIG. 1A is a block diagram depicting an architectural overview of a networked system 100A for facilitating RESTful web service communications using an OData protocol in connection with an example embodiment. The OData protocol uses a series of RESTful web service communications, specifically HTTP methods (such as GET, POST, PUT, and DELETE), to query and interact with data from a data service.

As illustrated, the networked system 100A includes one or more client devices such as client mobile devices 102A, 102B, 102C, being network accessible via an internet connection, and connected to a reverse proxy 104 in a network demilitarized zone (DMZ). Each of the client mobile devices 102A, 102B, 102C is configured to transmit and receive respective OData communications with the reverse proxy 104. The respective OData communications may include one or more OData requests (such as an OData request 110 shown upon further transmission to a gateway 106 from the reverse proxy 104) or the response to such OData requests.

The reverse proxy 104 is configured to transmit the OData request 110 to an enterprise data system such as a back-end service 108 in a corporate intranet/backend network. The gateway 106 can translate the OData request 110 to other proprietary protocols, such as Remote Function Call (RFC). The back-end service 108 may be configured to process the translated request, retrieve data or perform data operations as an appropriate response to the request, and return a response (not shown) for transmission back to the gateway. The gateway will translate the proprietary protocol back to OData. The OData response will then be transmitted from the gateway (which is located in the intranet/backend network), to the reverse proxy 104 (which is located in the DMZ), to the appropriate client mobile device 102A, 102B, 102C. Such a path of the OData communications between the mobile device 102A, 102B, 102C and the back-end service 108 can be considered an OData Channel

The various client devices 102A, 102B, 102C may process and consume other information used with the recognition and access of the OData connection and the OData channel. For example, a mobility platform 112 may be used to publish service information 114 related to the OData channel (for example, the OData Service Document and Metadata Document) to various consuming clients such as mobile devices. The mobility platform 112 may provide facilities to publish and discover such OData service documents, to enable proper establishment of device connections, authentication, and onboarding. Other information related to the OData channel and related services may be communicated to the consuming clients directly or indirectly from components located accessible in the DMZ, the corporate intranet, or the internet.

FIG. 1B is a block diagram depicting an architectural overview of a system for facilitating obfuscated RESTful web service communications using an OData protocol in connection with an example embodiment. Similar to the previously described elements of FIG. 1A, various client devices 102A, 102B, 102C are used to communicate the OData request 110 to the reverse proxy 104, with an OData channel, and the various client devices 102A, 102B, 102C obtain service information 114 from a mobility platform 112 or other service information source.

In the system of FIG. 1B, an OData obfuscation service (OOS) 118 is located between the reverse proxy 104 and the gateway 106 to intercept OData communications such as the OData request 110. The OOS 118 acts as a middle party with both client and server functionality to handle communications in both directions. The OOS 118 performs functions of an OData server to receive and handle OData requests from the consumer client, i.e. the mobile devices 102A, 102B, 102C. The OOS 118 also performs functions of an OData client, to forward incoming OData requests such as the OData request 110 from the mobile device (102A, 102B, 102C) to the gateway 106 and the back-end service 108. The OOS 118 may perform this by forwarding an OData request 120 to the back-end service 108 operating independently of the OOS 118, and receiving a corresponding OData response 121.

After receiving the OData response 121 from the gateway server 106 (and correspondingly, from the back-end service 108), the OOS 118 can perform the data obfuscation on the received data. The OOS 118 provides an OData obfuscation server to transmit an OData response upon completion of the data obfuscation. The data obfuscation, as further detailed in the following, may apply various rules and determine various contexts to modify the data as retrieved from the back-end service 108 into obfuscated data.

Once the response is obfuscated according to the defined rules

and determined contexts by the OOS 118, the obfuscated response may be returned to the mobile device by the OData obfuscation server. As shown, an OData response, OData' 311, containing obfuscated data is communicated from the OOS 118 to the reverse proxy 104, for ultimate communication to the appropriate mobile device 102A, 102B, 102C. To the requesting client, the interception of the OData request 110 by the OOS 118 may be fully transparent. The location of the OOS 118 may be indicated by the service information 114 as a replacement for the gateway 106. In other configurations, a gateway or other component may be used to redirect the OData request 110 to the OOS 118.

Using OData instead of proprietary enterprise service protocols for communications between client devices and backend systems may provide a number of benefits. OData is an open standard and many vendors provide OData Software Development Kits (SDK) and interfaces for clients such as mobile devices. Client applications such as mobile applications that connect to backend systems via OData can typically be developed independently of any existing backend system. Additionally, OData SDKs may provide the possibility to simulate backend calls, so that a developer can optimize the OData interfaces without affecting the structure or interfaces of backend systems.

Thus, in a mobile application development setting, the corresponding OData services can be used once the developer of a mobile application finalizes the OData interfaces. When both parts are done, the mobile application is able to consume the OData services provided by the backend. The appropriate level of control over data access, access control changes, and obfuscation may be provided and changed at the OOS 118 at any time without needing changes to the backend or the mobile application.

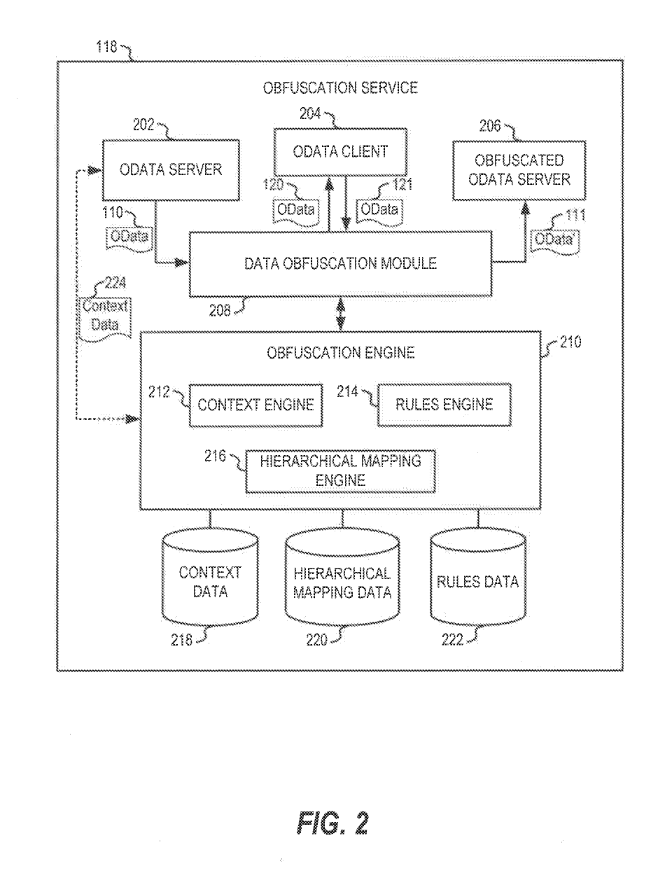

The OOS 118 may include or integrate with any number of components for determining the amount and level of data obfuscation and manipulation (such as the components and configuration of an OOS 118 depicted in further detail in FIG. 2). When the OData interfaces from the OOS 118 are finalized, it is also possible to independently develop the mapping of the OData service to OOS components such as a rules engine and context engine, and define the corresponding obfuscation rules. These obfuscation rules can be added transparently and even for existing mobile applications that use OData for communication with the backend systems.

Another benefit of OData communications is that the OOS 118 can request additional data from the mobile device, over the HTTP connection utilized by an OData or other RESTful web service connection. The OOS 118 may request additional dynamic information from the client useful in determining the type and amount of obfuscation, or other context values. For example, the OOS 118 may request information such as the current GPS location or device type, and use this information for application of data obfuscation rules.

Thus, use of an OData obfuscation solution enables definition of simple or complex obfuscation rules. These obfuscation rules may not only use data from the backend system, provided by the OData services, but may also access data from the client determined from real time. Further, it is possible to define additional contexts on the obfuscation service, such as security level or hierarchical relationships, which can also be factored by the obfuscation rules.

FIG. 2 is a block diagram showing components of an obfuscation service (OOS 118) including various subsystems, modules, and data stores to perform data obfuscation in an OData channel. As depicted, OOS 118 includes a series of communication components, including an OData Server 202, an OData Client 204, and an Obfuscated OData Server 206 used to facilitate communications among requesting client devices and back-end services. The operations of these communication components are managed by a data obfuscation module 208, which in turn communicates with an obfuscation engine 210.

The data obfuscation module 208 is configured to manage the receipt and transmission of various OData requests. As an operational example, an initial OData request 110 is received at the OData server 202 and communicated to the data obfuscation module 208 for processing. The data obfuscation module 208 provides an OData request 120 through OData client 204 to a backend service (not shown) that accepts OData web service communications. The result of the web service communication with the backend service, an OData response 121, is received at the OData client 204 and provided to the data obfuscation module 208.

The data obfuscation module 208 operates to determine the data within the OData response 121 and apply obfuscation to the data as appropriate. The data obfuscation module 208 communicates with the obfuscation engine 210 to determine the appropriate rule to apply, which may be dependent on context of the requesting device or other factors.

The obfuscation engine 210 may include separate operations occurring with a context engine 212, a rules engine 214, and a hierarchical mapping engine 216. The context engine 212 operates to determine the appropriate context for data obfuscation (which may affect the application of certain rules). The rules engine 214 operates to determine the appropriate rules for data obfuscation based on a determined context. The hierarchical mapping engine 216 operates to determine the appropriate rules or context to apply based on a hierarchical mapping of relationships to rules (such as security levels and associated rules to a determined level). Data accessed by the components of the obfuscation engine 210 may be determined from any combination of a context data store 218, a hierarchical snapping data store 220, or a roles data store 222.

The context engine 212 may operate to further obtain context information in real-time, from external sources or from the requesting device itself. The context engine 212 may facilitate communications to the requesting device using OData server 202, to obtain a set of context data 224 directly from the requesting device. One of the examples of context data from the requesting device includes GPS location data from a mobile device. The context data 224 may be obtained through use of OData communications or other communication techniques with the requesting device.

Upon determination of the correct context and rules for data obfuscation (and any hierarchical mappings between context and rules), the data obfuscation module 208 operates to perform obfuscation upon the data payload from the OData response 121. The result of the obfuscation, OData' response 111, is transmitted to the requesting client using the obfuscated OData server 206.

The OOS 118 may further include a reasoning engine (not shown) integrated into the data obfuscation module 208. As the various contexts are defined (such as security level, blackout period, and detailed access restrictions), such contexts may be provided and processed by the reasoning engine. The reasoning engine may operate to calculate various data rules and provide input to the data obfuscation module 208. The reasoning engine may also operate to establish combination of contexts, factoring multiple contexts such as a combination of security level, location, and device type. The operations performed by the reasoning engine may also be directly integrated within the data obfuscation module 208.

Although FIG. 2 shows the OOS 118 as a single entity, it is to be appreciated that the OOS 118 or any similar obfuscation service may include fewer or more modules and components from those shown in FIG. 2, and integrated into a single system or from the operation of independent systems and subsystems. For example, the data provided by the rules data 218, hierarchical mapping data 220, and context data 222, may be provided from one or more data sources external to the OOS 118. The obfuscation engine 210 may operate as a standalone service which provides data to the OOS 118 regarding applicable policies and rules. Further, additional and different modules and other types of integration with the back-end service or the requesting client device may be provided for the OOS 118.

Each of the client devices, the reverse proxy, the OOS, the gateway, the back-end service, and other processing components depicted in FIG. 1A, FIG. 1B, and FIG. 2 may be embodied, individually or in combination, in a computing device in the form of, for example, a personal computer, a server computer, a mobile computer, or any other suitable computing device. In various embodiments, the computing device may be used to implement computer programs, logic, applications, methods, processes, or software to provide data obfuscation operations, as described herein.

With respect to the system configurations depicted in FIG. 1A, FIG. 1B, and FIG. 2, it should be appreciated that in other embodiments, the systems and network configurations may include fewer or more components apart from those shown. For example, in example embodiments, the data services provided in the corporate intranet/backend can be integrated within fewer or additional components. The components and respective modules shown in FIG. 1A, FIG. 1B, and FIG. 2 may be in the form of software that is processed by a processor. In another example, as explained in more detail below, the components and respective modules shown in FIG. 1A, FIG. 1B, and FIG. 2 may be in the form of firmware that is processed by application specific integrated circuits (ASIC), which may be integrated into a circuit board. The components and respective modules shown in FIG. 1A, FIG. 1B, and FIG. 2 also may be in the form of one or more logic blocks included in a programmable logic device (for example, a field programmable gate array). The components and respective modules shown in FIG. 1A, FIG. 1B, and FIG. 2 may be adapted, and/or additional structures may be provided, to provide alternative or additional functionalities beyond those specifically discussed in reference to FIG. 1A, FIG. 1B, and FIG. 2. Examples of such alternative or additional functionalities will be discussed in reference to the flow diagrams and method operations discussed below.

Although FIG. 1A, FIG. 1B, and FIG. 2 provide illustration of mobile client scenarios, it will be understood that the applicability of the presently described data obfuscation techniques and components are not limited to mobile client scenarios. A variety of clients and client types (including combinations of mobile and non-mobile client types) may be used.

Data obfuscation of web-service and OData-based communications provides flexibility for communication techniques, and removes many of the modifications needed for implementing obfuscation directly at back-end systems. Further, use of an OOS in an OData-based consumption system helps consumers leverage user relationships and access rules already in place in the enterprise data system. User access controls are likely to already exist in an enterprise data source such as an ERP/CRM system, and may be mapped within an obfuscation engine or other data subsystem of an OOS.

Thus, with use of an OOS, a particular security level and access result does not need to be expressly defined for every particular user or access. Rather, a security level or other access control for data obfuscation can be generic and simply mapped to a context and rules. Information may also be retrieved dynamically from the requesting device, including real-time information from mobile devices such as location and user information. Such real-time user information may be correlated with information from a back-end service to provide a correct context and usage for obfuscation.

The use of data obfuscation may be provided in a variety of scenarios for a variety of datatypes. One implementation of complex data obfuscation scenarios is to provide contexts, such as security levels and obfuscation rules that are defined according to determined contexts. The following describes the use and operation of such data obfuscation scenarios, and techniques for hierarchical mappings of obfuscation rules to contexts.

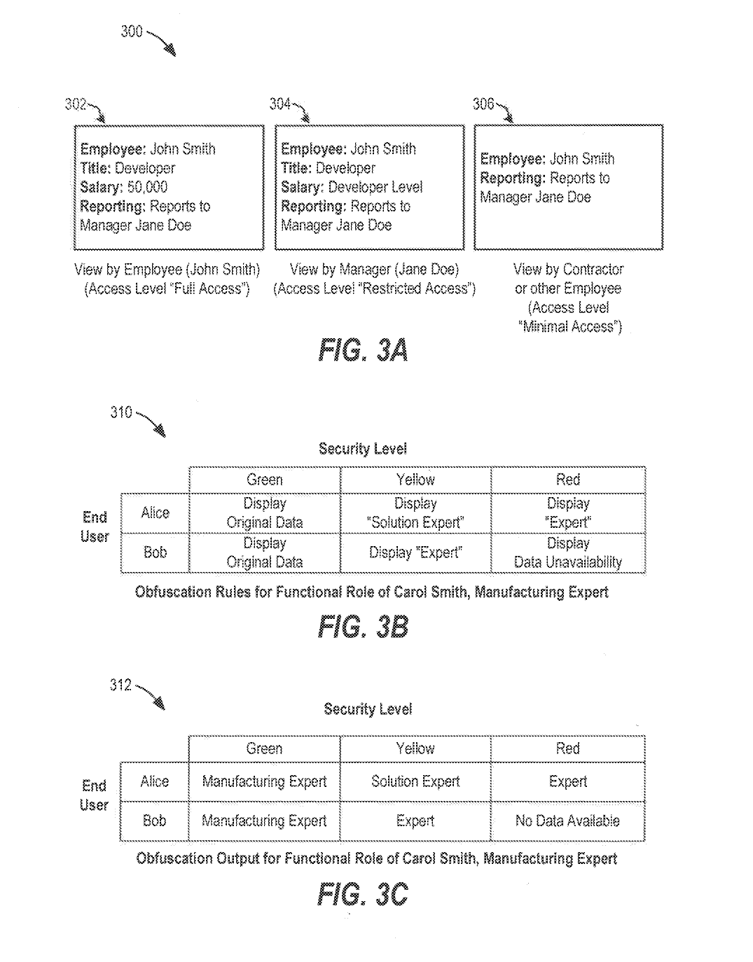

For example, in a simple human resource setting, data for an employee in a company address book may be accessed by the employee, a manager, and a contractor. FIG. 3A provides an illustrated example of data views 300 of the company address book for the employee, implementing three levels of data obfuscation for each end user based on an access level, for such a setting.

An intended obfuscation output may be intended to allow the employee to see all of his or her data, including sensitive information such as the reporting hierarchy and salary. This is depicted in data view 302, where the employee, who has an access level of “Full Access” for his or her own data, does not receive any obfuscated data output.

In contrast, the intended obfuscation output for another user such as the employee's manager (“Jane Doe”), may be intended to allow the manager to only see the reporting hierarchy and the salary group only. This is depicted in data view 304, where the manager (“Jane Doe”), who has an access level of “Restricted Access” for the employee's data, receives some fields of obscured data (masking the exact salary number with a “Developer Level” descriptor).

Likewise, the intended obfuscation output for still another user such as a non-employee contractor, may be intended to allow the contractor to only see the employee's name and reporting information. This is depicted in data view 306, where the contractor, who has an access level of “Minimal Access” for the employee's data, receives obscured data by only receiving access to the employee name reporting hierarchy (with the existence of other data fields hid entirely).

Such obfuscation rules and output can be defined according to the user roles and definitions that are available in the backend system or the obfuscation service. However, it is also possible to use dynamic client-determined definitions (such as a GPS location) for purposes of obfuscation.

Location data may be obtained in real-time directly from a client device. Modern smartphones, for example, are typically able to capture GPS coordinates. Such GPS coordinates of smartphones may be coordinated with logical locations through services that convert or generalize addresses to GPS coordinates (or GPS coordinates to addresses). By converting addresses of a business location to GPS coordinates, a context location may be established for the two values: in_office and out_of office. For example, if the current GPS location of a user's smartphone is within a certain range of GPS coordinates, e.g. 500 m, away from the GPS position of the company address, the current value of the context may be established as is in_office otherwise it is out_of_office,

Continuing with the example of location data, obfuscation rules may be defined for smartphone users depending on their absolute distance from the company office and the context values. Certain sensitive data may not be accessed outside of the company facility from mobile devices, while providing mobile devices of authorized users with full access to the information while at the company office location. For example, the employee may only see a rounded salary when looking up the salary from a mobile device outside the company premises, while seeing a precise number when on the company premises.

Furthermore, data obfuscation rules can also be defined using contexts that are independent from the backend systems or mobile devices. For example, if the company has defined an overall security level with green, yellow, and red levels of alerts, a change to the security level for the user will change the types of data available for all fields associated with the security level. The employee will not even see his or her own salary when the security level for this field is changed from a green level (permissive) to a red level (restrictive).

One possible way to implement complex data obfuscation scenarios is to provide contexts, such as security levels, and obfuscation rules that are defined on the contexts. The following example illustrated in FIGS. 3B and 3C provides views of potential mappings between security level and an end user, and illustrates the relationship between rules and contexts.

Assume a simple application, e.g., a SAP® Customer and Contacts mobile application, is used to extract customers, contacts, and sales order data from a backend system and displays the data on a mobile device. To keep this example very simple, a user intends to lookup the functional role of an existing contact “Carol Smith”. The contexts that should influence the value of the functional role, in this example, are the end user and a security level.

Here the assumption is that two end users exist, Alice and Bob, and three security levels exist, green, yellow and red. Now depending on the user and security level, the mobile application should display the values indicated in table 310 of FIG. 3B. Namely, six possible rules (three values for each of the two users) may be used. Table 310 indicates for this example that in the security level yellow, the user Alice will see the string “Solution Expert”, while Bob will see the string “Expert”. When the security level changes to the value green, both end users will see the original data that is stored in the backend system, which is “Manufacturing Expert.” In the security level red, the user Alice will see the string “Expert”, while the user Bob will see the string “No Data Available.” The output for these values and rules is depicted in Table 312 in FIG. 3C.

While definitions of the six possible rules are manageable in this very simple example, the number of rules will grow exponentially with the number of contexts that are used for data obfuscation. In the example of FIG. 3B and FIG. 3C, there are only two contexts with two and three values, which potentially result in six rules. These rules, however, are only defined for one single field (functional role) in one single contact (Carol Smith). In a real world scenario, rules would likely need to be defined for potentially all fields of Carol Smith and potentially for ail contacts.

As the examples of FIG. 3B and FIG. 3C illustrate, the number of data obfuscation rules can easily grow and become difficult to maintain or to calculate in real time. One way to address this challenge is to use parameterized obfuscation rules, for example, “Contact of $(username)” value. Here the variable username is used to make the rule independent of the specific end user, so that a single generic rule could be applied for all users. For the user Alice in the example rules above, the rule would result in the output string “Contact of Alice”, whereas for the user Bob the rule would result in the output string “Contact of Bob.” To further extend the concept of generalizing rules, hierarchies may be defined within the contexts as appropriate.

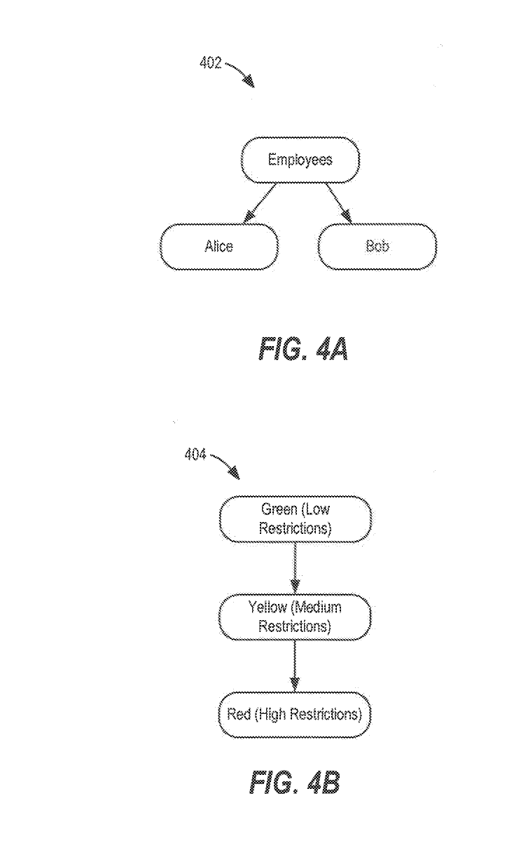

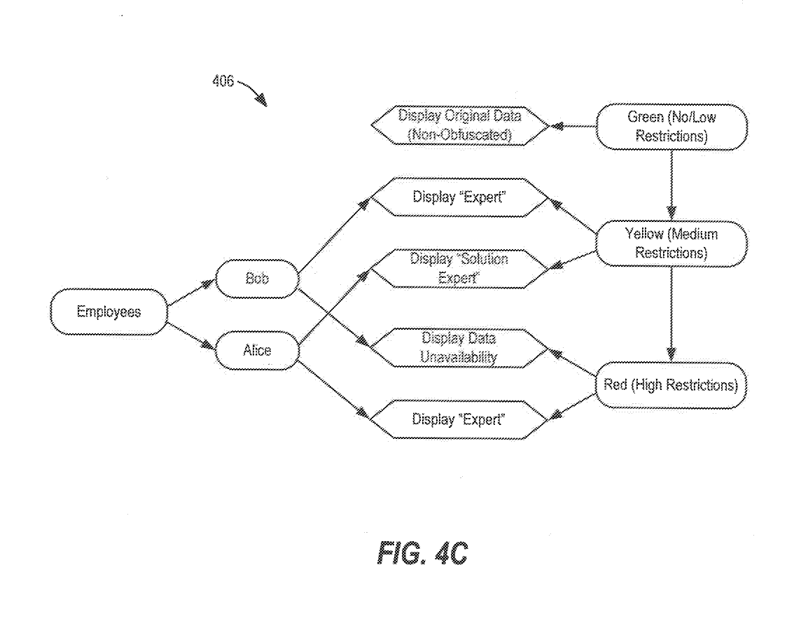

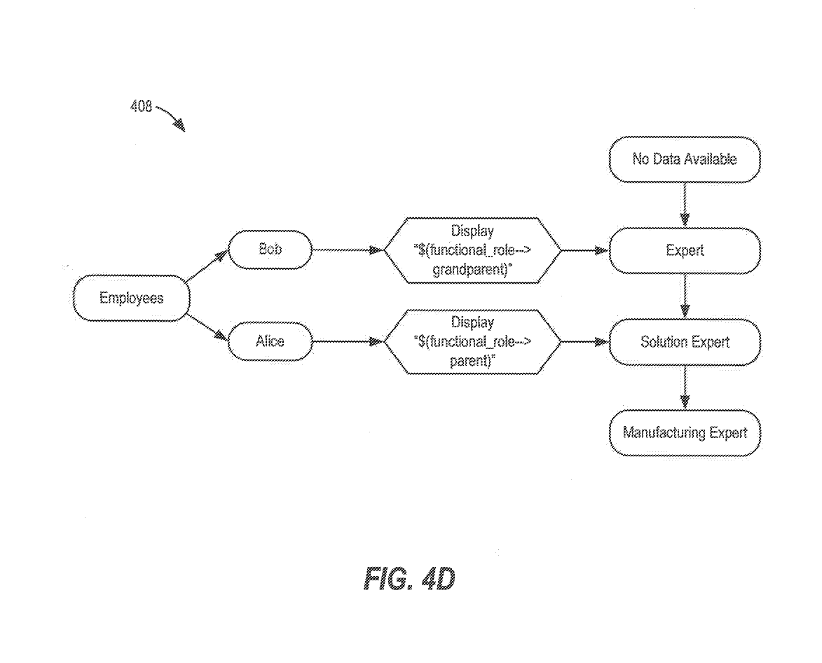

FIG. 4A and FIG. 4B provide an illustration of two types of hierarchies usable in connection with data obfuscation operations. Higher-level nodes will typically represent all the nodes below and thus contain more generic information. Data obfuscation rules may be defined to reside at or correlate with the most appropriate levels within the hierarchies. The lower nodes in a hierarchy can inherit the data obfuscation rules from higher levels. Of course, it must be possible to override rules from higher levels in the lower levels of the hierarchy. Applying hierarchical concepts to the example rules of FIG. 3A and FIG. 3B, hierarchies may be defined for the two contexts: end users and security level.

FIG. 4A illustrates a hierarchy 402 between end users. FIG. 4B likewise illustrates a hierarchy 404 among security levels. Note the difference between the two hierarchies: for the end user hierarchy 402 one additional node is defined that represents all employees, while for the security level hierarchy 404 a linear hierarchy is defined that represents an order. The security level hierarchy 404 includes an assumption that the level “yellow” is more restrictive than the level green, and that level “red” as is more restrictive than the level “yellow.” In the end user hierarchy 402, a simple hierarchical relationship exists such that the higher-level nodes contains all lower nodes; whereas in the security level hierarchy 404, the hierarchy is defined by the meaning or semantics of the node values.

With hierarchies, it is possible to define the rules expressed in the examples of FIG. 3B and FIG. 3C in a hierarchical mapping. The results of this mapping are provided in hierarchical mapping 406 in FIG. 4C. For the security level green, information is not needed about the end user, since the functional role of the contact Carol Smith is unrestricted and not obfuscated at all. The rules for the restricted security levels yellow and red are tied to a specific value for each user.

With a hierarchical mapping between hierarchies and rules, obfuscation rules can be defined at an abstraction level that is most appropriate to the requirements of the obfuscation output. This will not only reduce the number of obfuscation rules, it will also make the management of the rules easier, since it is possible to provide generic rules and add specific rules or rule overrides, where needed.

Having defined a set of hierarchical contexts, hierarchies may be provided within rule sets as well. Assume there is also a hierarchy within the functional roles that represents more generic terms for the role Manufacturing Expert, containing the values Manufacturing Expert, Solution Expert, Expert, and No Data Available, as shown in the hierarchy 408 of FIG. 4D. Two obfuscation rules for the security level yellow may be defined by introducing the variable functional_role, which represents the original value of the contact's functional role (“Manufacturing Expert” in the hierarchy), and the possibility to move one or two levels up in the hierarchy with the expressions functional_role-->parent and functional_role-->grandparent respectively as indicated in FIG. 4D.

As shown in the hierarchy 408 of FIG. 4D, the obfuscation rule for Alice displays the value of the expression functional_role->parent, which in this example is the value Solution Expert for the contact Carol Smith. The rule for Bob provides the value of the node that is two levels up in the hierarchy, i.e. the value Expert. This construct is very powerful for data obfuscation applications, because it provides a very natural way of organizing and generalizing data according to an ontology.

Another example of hierarchical mappings is the obfuscation of location information. Suppose a hierarchical context is established for locations that includes continents, countries, regions, and cities. In such an example, moving to a higher level in a location hierarchy provides a very useful obfuscation that may be used to generalize locations of addresses, storage locations, facilities, and the like. Thus, if location data is obtained in real-time (i.e., from the client device at the time of a query), a complex hierarchical obfuscation may be applied to determine a more generic rule for data obfuscation.

Location data may be obtained in real-time directly from the client device. Modern smartphones, for example, are typically able to capture GPS coordinates. Such GPS coordinates of smartphones may be used in data obfuscation of location through services that convert or generalize addresses to GPS coordinates (or GPS coordinates to addresses). By converting addresses of a business location to GPS coordinates, a context location may be established for the two values: in_office and out_of_office. For example, if the current GPS location of a user's smartphone is within a certain range of GPS coordinates, e.g. 500 m, away from the GPS position of the company address, the current value of the context may be established as is in_office otherwise it is out_of_office. Obfuscation rules may be defined for smartphone users depending on their absolute distance from the company office and the context values. For example, certain sensitive data may not be accessed outside of the company facility from mobile devices, while providing mobile devices of authorized users with full access to the information while at the company office location.

The previous described examples of hierarchies considered strings for values in context nodes as well as in the definition of obfuscation rules. Handling real numbers or other data types may also be facilitated. Further, data obfuscation may operate to not only generate a value, but to replace values or portions of data types (even such complex obfuscation such as obfuscating only a portion of a business document or multimedia data file). Other types of hierarchies and ontological relationships, and mappings between such hierarchies and ontological relationships, may be factored for use in data obfuscation operations.

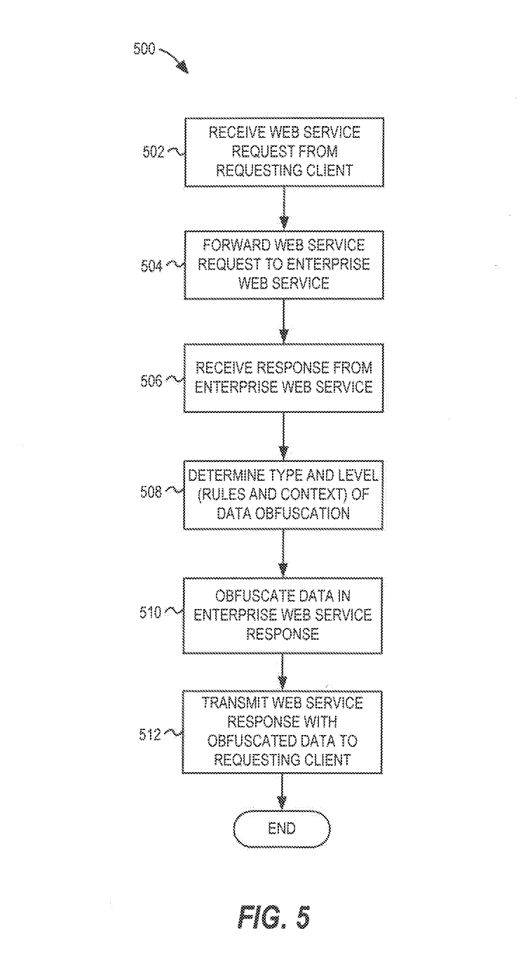

FIG. 5 depicts a flow diagram of a general overview of a method 500 for performing data obfuscation of a web service request with an obfuscation service, in accordance with an example embodiment. The method 500 may begin at operation 502 by receiving a web service request from a requesting client. This web service request may be intercepted, redirected, or otherwise provided to the obfuscation service to facilitate obfuscation of data in the eventual response to the web service request.

In operation 504, the web service request is forwarded, redirected, or otherwise transmitted to an enterprise web service to retrieve data in a response. The web service request may be unaltered from the version provided by the requesting client, or the web service may include additional or changed information from the version provided by the requesting client. The web service request may be transmitted using a REST-based protocol such as OData, and may include standard HTTP create, read, update, and delete commands (POST/GET/PUT/DELETE) to perform data operations according to the data transmission protocol or data format involved in the request.

Operation 506 includes receiving and processing a response from the enterprise web service, in response to the request forwarded in operation 504. The processing in this operation may include extracting relevant data fields and data values from the response, or identifying a data payload from the relevant data fields.

Operation 508 includes operations to determine the type and level of data obfuscation to apply to the data in the enterprise web service response. The type and level of data obfuscation may be determined according to one or more rules. These rules may be determined independently or in conjunction with one or more contexts (for example, contexts which determine which specific rule or sets of rules to select and apply for data obfuscation).

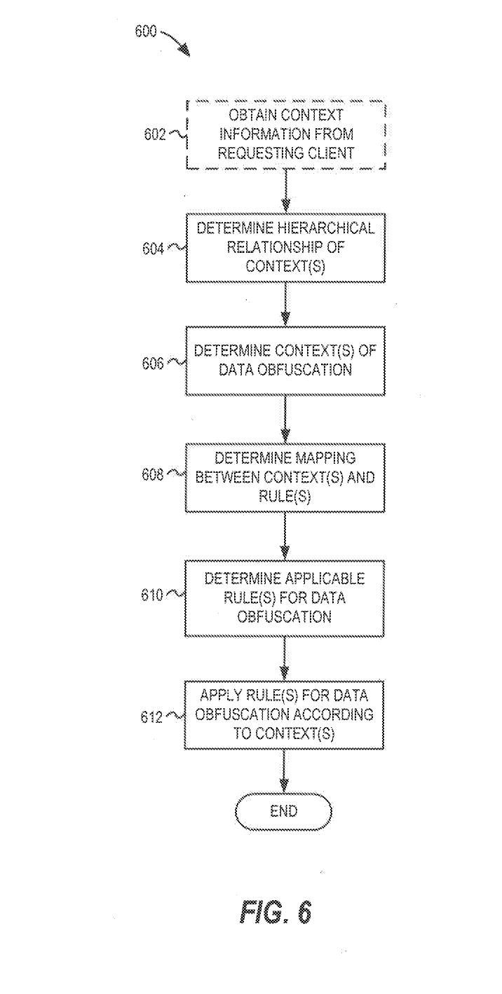

Operation 510 includes operations to obfuscate data from the web service response, using the determined type and level of data obfuscation. The operations to determine the type and level of data obfuscation, and to obfuscate data, may include operations of a data obfuscation method 600 as depicted in FIG. 6 and further described herein. The particular data obfuscation operations may be used to determine and apply data obfuscation rules to data. Other operations or sequences of operations may also be used to perform the data obfuscation on the data.

Operation 512 includes providing a response to the requesting client. The response may be provided from the obfuscation service by transmitting a web service response including the obfuscated version of the data to the requesting client. The web service response may contain additional non-obfuscated data, and may also be provided to additional clients or destinations according to contexts or other determined inputs.

In an example embodiment, the method 500 may be implemented by the OOS 118 included in the system 100 of FIG. 1B. The method 500 may be performed in whole or in part by the data obfuscation module 208 or by separate subcomponents of the OOS 118 including the obfuscation engine 210, the context engine 212, the rules engine 234, or the hierarchical mapping engine 216. Further, communication operations for receiving and responding to OData requests may be performed by the OData server 202, the OData client 204, and the obfuscated OData server 206.

Referring to FIG. 6, the method 600 for obfuscating data for a

web service response may begin at operation 602. Operation 602 is performed optionally in some embodiments, and may include obtaining context information from the requesting client device or user.

At operation 604, any known context information (or other information relevant to the data obfuscation operation) is used to determine a hierarchical relationship of one or more contexts. For example, location context information obtained from a client device may be correlated to an identified context in a context hierarchy of geographical contexts. Likewise, common or parent contexts from a known context in a hierarchical relationship may be located.

At operation 606, one or more contexts of the data are identified and determined for use in data obfuscation operations. For example, a location context identified based on client device information, a security context based on hierarchical security levels, and a user context based on user hierarchical relationships may each be determined and identified for use in the data obfuscation.

At operation 608, mappings between the identified contexts and one or more rules are determined. A mapping of a security context may produce a different result based on an identified user context in a user hierarchical relationship (such as the two different rules applied to the “Red (High)” security level for the users Alice and Bob depicted in FIG. 4C).

At operation 610, the mappings determined in operation 608 and any other input information is used to determine applicable rules for data obfuscation operations. The applicable rules that are determined by operation 610 may provide a specific type, format, or value of data obfuscation, and may be dependent on various internal or external factors of the obfuscation service.

At operation 612, the particular applicable rules that are determined by operation 610 are applied to data (such as the data pay load from an enterprise web service). The applicable rules are applied according to the determined contexts (such as the determined contexts of operation 606) to ensure a proper output. The data obfuscation method 600 then ends after operation 612.

It will be understood that various modifications to the order or performance of the sequence of illustrated steps of method 600 may result in the same or different result (namely, the data obfuscation result). Further, although method 600 may be performed in connection with the data obfuscation operation 510 of method 500, it will be apparent that the data obfuscation method 600 may be performed separately or in connection with other operations of a data obfuscation service.

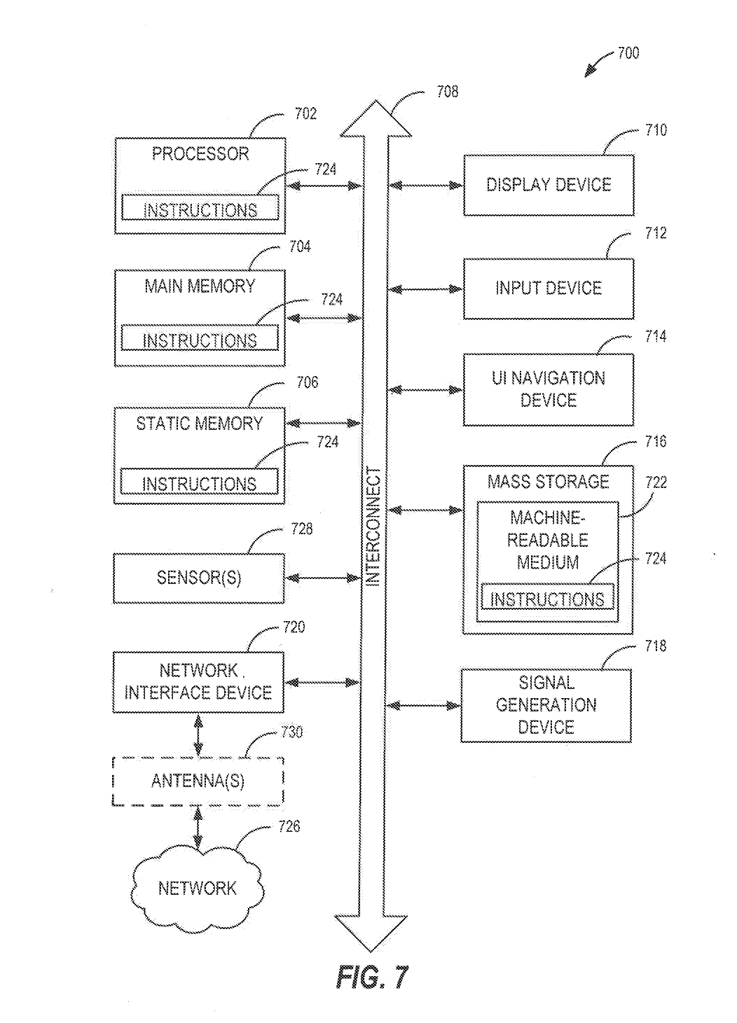

FIG. 7 depicts a block diagram of a machine in the example form of a computing device 700 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computing device 700 includes a processor 702 (e.g., a central processing unit (CPU), a graphics processing unit (GPU) or both), a main memory 704 (e.g., random access memory), and static memory 706 (e.g., static random-access memory), which communicate with each other via interconnect (e.g., bus) 708. The computing device 700 may further include video display device 710 (e.g., a plasma display, a liquid crystal display (LCD) or a cathode ray tube (CRT)). The computing device 700 also includes an alphanumeric input device 712 (e.g., a keyboard), a user interface (UI) navigation device 714 (e.g., a mouse), a disk drive unit 716, a signal generation device 718 (e.g., a speaker), and a network interface device 720.

The mass storage unit 716 (e.g., a disk drive or other type of non-volatile memory storage) includes a machine-readable medium 722 on which is stored one or more sets of data structures and instructions 724 (e.g., software) embodying or utilized by any one or more of the methodologies or functions described herein. The data structures and instructions 724 may also reside, completely or at least partially, within the main memory 704 and/or within the processor 702 during execution thereof by computing device 700, with the main memory 704 and processor 702 also constituting machine-readable, tangible media.

The data structures and instructions 724 may further be transmitted or received over a computer network 726 via network interface device 720 utilizing any one of a number of well-known transfer protocols (e.g., HTTP). The network interface device 720 may include or operably communicate with one or more antennas 730, transceivers, or other wireless communications hardware to facilitate the connection with the computer network 726.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the computing device 700) or one or more hardware modules of a computer system (e.g., a processor 702 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 702 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 702 configured using software, the general-purpose processor 702 may be configured as respective different hardware modules at different times. Software may accordingly configure a processor 702, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 702 or processor-implemented modules. The performance of certain of the operations may be distributed among the one or more processors 702, not only residing within a single machine, but deployed across a number of machines. In some example embodiments, the processors 702 may be located in a single location (e.g., within a home environment, an office environment or as a server farm), while in other embodiments the processors 702 may be distributed across a number of locations.

While the embodiment(s) is (are) described with reference to various implementations and exploitations, it will be understood that these embodiments are illustrative and that the scope of the embodiment(s) is not limited to them. In general, techniques for data searches using context information may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method for data obfuscation performed at an obfuscation service, the obfuscation service coupled to a network and including at least one processor, and the method comprising:
receiving a web service request from a client of a web service at an obfuscation service, the web service request being provided from the client to the web service through the obfuscation service;
forwarding the web service request from the obfuscation service to the web service;
receiving a web service response for the web service request at the obfuscation service, the web service response including data;
obfuscating the data according to one or more data obfuscation rules determined for the client and the web service request; and
transmitting an obfuscated web service response from the obfuscation service to the client, the obfuscated web service response including the obfuscated data.

2. The method of claim 1, wherein the web service is hosted by an enterprise data service operating independently of the obfuscation service, and wherein the web service is a Representational State Transfer (REST) web service communicating according to a date transfer protocol standard.

3. The method of claim 2, wherein the data transfer protocol standard is a Open Data (OData) protocol standard.

4. The method of claim 1, further comprising:
determining the one or more data obfuscation rules from an obfuscation engine operably coupled to the obfuscation service.

5. The method of claim 4, further comprising:
factoring one or more contexts for data obfuscation to determine the one or more data obfuscation rules.

6. The method of claim 5, further comprising:
requesting, from a client device operating the client, data related to the one or more contexts for data obfuscation; and
receiving, from the client device, the data related to the one or more contexts for data obfuscation;
wherein factoring the one or more contexts for data obfuscation includes using the data related to the one or more contexts received from the client device.

7. The method of claim 6, wherein the client device is a mobile device, and wherein the data related to the one or more contexts received from the client device provides location information including global positioning system (GPS) coordinates, the location information being used to correlate the GPS
coordinates to a location context.

8. The method of claim 5, wherein context data for the one or more contexts is provided from the client, from the obfuscation service, or from a data source accessible by the obfuscation service.

9. The method of claim 1, wherein the one or more data obfuscation rules are determined based on one or more contexts mapped in a hierarchy, and wherein the one or more data obfuscation rules are mapped to the one or more contexts according to hierarchical relationships.

10. A system comprising:
an obfuscation service configured to obfuscate data provided from data communications with an enterprise data web service, the obfuscation service including:
a server configured to receive a web service request from a requesting device; and
a client configured to communicate with the enterprise data web service and obtain enterprise data from the enterprise data web service according to the web service request;
wherein the obfuscation service is further configured to provide a response of the web service request to the requesting device, the response including an obfuscated version of the enterprise data;
a data obfuscation module configured to produce the obfuscated version of the enterprise data using one or more data obfuscation rules; and
an obfuscation engine configured to determine the one or more data obfuscation rules, the obfuscation engine including:
a rules engine configured to identify the one or more data obfuscation rules from one or more rules data sources.

11. The system of claim 10, the obfuscation engine further including:
a context engine configured to determine one or more contexts of data obfuscation, and determine the one or more data obfuscation rules to apply to the enterprise data based on the one or more contexts, wherein the one or more contexts are provided from one or more context data sources.

12. The system of claim 11, the obfuscation engine further including:
a hierarchical mapping engine used to determine a mapping between the one or more data obfuscation rules and the one or more contexts, wherein the one or more data obfuscation rules are mapped to the one or more contexts with hierarchical relationships in a hierarchical data source.

13. The system of claim 12, wherein mappings in the hierarchical data source include a user access control mapping between a plurality of users and a plurality of access control levels, wherein the obfuscated version of the enterprise data is based upon an access control level determined for a specific user of the requesting device from the user access mapping.

14. The system of claim 11, wherein the context engine is configured to establish one or more communications with the requesting device, receive data from the requesting device using the one or more communications, and determine a context from the data received from the requesting device.

15. The system of claim 10, further comprising:
a mobility platform configured to provide, to the requesting device, service information for the server of the obfuscation service to receive the web service request.

16. The system of claim 10, wherein the enterprise data web service is a Representational State Transfer (REST) web service accepting communications according to an Open Data (OData) protocol standard.

17. A non-transitory, computer-readable storage medium that stores instructions, which, when performed by a computer, cause the computer to perform operations comprising:
receiving an Open Data (OData) web service response for an OData web service request originating from a client, the OData web service response provided in an OData protocol communication with an enterprise web service, and the OData web service response including data provided from an enterprise data service coupled to the enterprise web service;
performing data obfuscation on the data provided from the enterprise data service according to one or more data obfuscation rules, the one or more data obfuscation rules determined from an access control context for the client and the OData web service request originating from the client; and
transmitting the OData web service response to the client in an OData protocol communication, the OData web service response including results of the data obfuscation.

18. The non-transitory computer-readable storage medium of claim 17, further comprising instructions which cause the computer to perform operations including:
determining the one or more data obfuscation rules from a rules engine and a rules data store.

19. The non-transitory computer-readable storage medium of claim 18, further comprising instructions which cause the computer to perform operations including:
factoring one or more contexts for data obfuscation to determine the one or more data obfuscation rules, the one or more contexts being provided from a context data store.

20. The non-transitory computer-readable storage medium of claim 19, wherein the one or more data obfuscation rules are mapped to one or more contexts in hierarchical relationships, wherein the hierarchical relationships are determined from a hierarchical mapping data store which provides hierarchical mappings between contexts and rules.
